(19) United States
(12) Patent Application Publication
(10) Pub. No.: US 2024/0072358 A1
(43) Pub. Date: Feb. 29, 2024

(54) ACCOMMODATION MECHANISM, UNMANNED AERIAL VEHICLE TRACKING DEVICE AND UNMANNED AERIAL VEHICLE TRACKING SYSTEM

(71) Applicant: Autel Robotics Co., Ltd., Shenzhen (CN)

(72) Inventor: Yangfan Li, Shenzhen (CN)

(73) Assignee: Autel Robotics Co., Ltd., Shenzhen (CN)

(21) Appl. No.: 18/239,659

(22) Filed: Aug. 29, 2023

(30) Foreign Application Priority Data
Aug. 29, 2022 (CN) 202222293529.X

(51) Int. Cl. H01M 50/249; H01M 10/48; H01M 50/262; H04Q 9/00

(52) U.S. Cl. CPC H01M 50/249; H01M 10/48; H01M 50/262; H04Q 9/00; H01M 2220/20

(57) ABSTRACT

The embodiments of the present disclosure disclose an accommodation mechanism, an unmanned aerial vehicle tracking device and an unmanned aerial vehicle tracking system, wherein the accommodation mechanism comprises a housing, a connection assembly, a cover plate and a locking assembly, the housing is provided with a battery holder formed from a side wall of the housing facing an internal recess of the housing, and the battery holder is configured to accommodate a battery; the connecting assembly is respectively connected to one end of the cover plate and the housing, and the cover plate is configured to rotate relative to the housing; the cover plate is configured to open or cover an opening of the battery holder; a locking assembly is provided on the housing and is configured to lock or unlock the cover plate.

### CROSS REFERENCE TO RELATED DISCLOSURE

This disclosure claims priority of Chinese Patent Disclosure No. 202222293529.X, filed on Aug. 29, 2022 and entitled “Accommodation mechanism, Unmanned Aerial Vehicle Tracking Device and Unmanned Aerial Vehicle Tracking system,” the entire disclosure of which is incorporated herein by reference for all purposes.

### BACKGROUND

With the development of an unmanned aerial vehicle (UAV) technology, the flight capability of the UAV has been greatly improved, and the tracking devices used to track the location of the UAV also have more stringent requirements, such as long endurance, high precision and wide range.

In implementing the embodiments of the present disclosure, the inventors have found that: in order to achieve a long endurance of the tracking device, the frequency of battery replacement is increased, so that the battery mounted on the tracking device is usually directly exposed, and the performance of the battery is degraded because the working environment of the tracking device is usually outdoors.

### SUMMARY

The embodiments of the present disclosure relate to the technical field of unmanned aerial vehicle communication, in particular to an accommodation mechanism, an unmanned aerial vehicle tracking device and an unmanned aerial vehicle tracking system The technical problem to be mainly solved by the embodiments of the present disclosure is to provide an accommodation mechanism, an unmanned aerial vehicle tracking device and an unmanned aerial vehicle tracking system, which can effectively improve the problem of battery performance degradation caused by battery exposure.

According to an aspect of the present disclosure, an accommodation mechanism, which includes a housing, a connection assembly, a cover plate and a locking assembly, the housing is provided with a battery holder formed from a side wall of the housing facing an internal recess of the housing, and the battery holder is configured to accommodate a battery; the connecting assemblies are respectively connected to one end of the cover plate and the housing, and the cover plate is configured to rotate relative to the housing; the cover plate is configured to open or covering an opening of the battery holder; and a locking assembly is provided on the housing and is configured to lock or unlock the cover plate.

According to the second aspect of the present disclosure, an unmanned aerial vehicle tracking device including a real-time dynamic measurement assembly, an antenna assembly, a power supply assembly, a controller and an accommodation mechanism as mentioned above; the housing is further provided with an accommodating cavity; the real-time dynamic measurement assembly and the antenna assembly are both provided on an outer surface of the housing, and the antenna assembly is configured to rotate relative to the housing; the power supply assembly is provided in the battery holder; the controller is provided in the accommodation cavity, and the controller is electrically connected to the real-time dynamic measurement assembly, the antenna assembly and the power supply assembly, respectively.

Alternatively, the cover plate is provided with an electric quantity display hole; the power supply assembly includes a battery body and an indicator lamp; the indicator lamp is electrically connected to the battery body; the indicator lamp corresponds to the electric quantity display hole; and the indicator lamp is configured to display the remaining electric quantity of the battery body.

Alternatively, the real-time dynamic measurement assembly includes a real-time dynamic measurement element, a support frame and a connecting cable, wherein one end of the support frame is fixed to a side wall of the housing, and the other end of the support frame is connected to the real-time dynamic measurement element; the real-time dynamic measurement element is provided with a first joint, one end of the connecting cable is connected to the first joint, and the other end of the connecting cable is fixed to the support frame; and the connecting cable is configured to connect with an external detection device.

Alternatively, the support frame includes a first rod, a second rod and a connector, wherein a first end of the first rod is fixed to a side wall of the housing, the connector is respectively connected to a second end of the first rod and a first end of the second rod, a second end of the second rod is connected to the real-time dynamic measurement element, and the first rod and the second rod are perpendicular.

Alternatively, a through groove is provided inside the second rod, the connecting cable is provided in the through groove, and the other end of the connecting cable is fixed to the first end of the second rod and protrudes out of the through groove.

According to the third aspect of the present disclosure, an unmanned vehicle tracking system which includes an unmanned vehicle tracking device as described above.

In the embodiments of the present disclosure, An accommodation mechanism according to an embodiment of the present disclosure includes a housing, a connection assembly, a cover plate and a locking assembly, the housing is provided with a battery holder formed from a side wall of the housing facing an internal recess of the housing, and the battery holder is configured to accommodate a battery; the connecting assemblies are respectively connected to one end of the cover plate and the housing, and the cover plate is configured to rotate relative to the housing; the cover plate is configured to open or cover an opening of the battery holder; a locking assembly is provided on the housing and is configured to lock or unlock the cover plate; and by providing a cover plate at the opening of the battery holder, direct exposure of the power supply assembly to the outside can be avoided, the working environment of the power supply assembly can be improved, and the service life of the power supply assembly can be extended. By providing a locking assembly, the cover plate can be locked on the housing, and the protection effect on the battery can be enhanced; in addition, the cooperation between the locking assembly and the connection assembly can facilitate the opening of the cover plate, and facilitate the access and placement of the battery.

### BRIEF DESCRIPTION OF THE DRAWINGS

In order that the detailed description of the present disclosure or the prior art may be more clearly understood, a brief description of the drawings that accompany the detailed description of the disclosure or the prior art is set forth below. Throughout the drawings, like elements or portions are generally identified by like reference numerals. In the drawings, elements or portions may not necessarily be drawn to scale.

FIG. 1 is a schematic diagram of an unmanned aerial vehicle tracking device according to an embodiment of the present disclosure.

FIG. 2 is an enlarged view of a portion A in FIG. 1.

FIG. 3 is a partial cross-sectional view of a containment mechanism according to an embodiment of the present disclosure.

FIG. 4 is an exploded view of the cover plate and connection assembly of the containment mechanism according to an embodiment of the present disclosure.

FIG. 5 is an exploded view of a locking assembly of the containment mechanism according to an embodiment of the present disclosure.

FIG. 6 is an exploded view of a real-time dynamic measurement assembly of an unmanned aerial vehicle tracking device according to an embodiment of the present disclosure.

FIG. 7 is a schematic diagram of a power module of an unmanned aerial vehicle tracking device according to an embodiment of the present disclosure.

### DETAILED DESCRIPTION

To facilitate an understanding of the present disclosure, a more particular description of the disclosure will be rendered by reference to specific embodiments thereof which are illustrated in the appended drawings. It will be understood that when an element is referred to as being “fixed to” to another element, it can be directly on the other element or intervening elements may be present. When an element is referred to as being “connected” to another element, it can be directly connected to the other element or intervening elements may be present. As used in the description, the terms “upper”, “lower”, “inner”, “outer”, “vertical”, “horizontal”, and the like indicate orientations or positional relationships based on the orientation or positional relationships shown in the drawings, are merely for convenience in describing and simplifying the present disclosure, and do not indicate or imply that the referenced devices or elements must have a particular orientation, be constructed and operated in a particular orientation, and thus are not to be construed as limiting the present disclosure. Further, the terms “first”, “second”, etc. are used for descriptive purposes only and are not to be construed as indicating or implying relative importance.

Unless defined otherwise, all technical and scientific terms used in the specification have the same meaning as commonly understood by a person skilled in the technical field to which this disclosure belongs. The terminology used in the description of the present disclosure is used for the purpose of describing particular embodiments only and is not intended to be limiting of the disclosure. As used herein, the term “and/or” includes any and all combinations of one or more of the associated listed items.

Further, the technical features involved in the different embodiments of the present disclosure described below can be combined with each other as long as they do not conflict with each other.

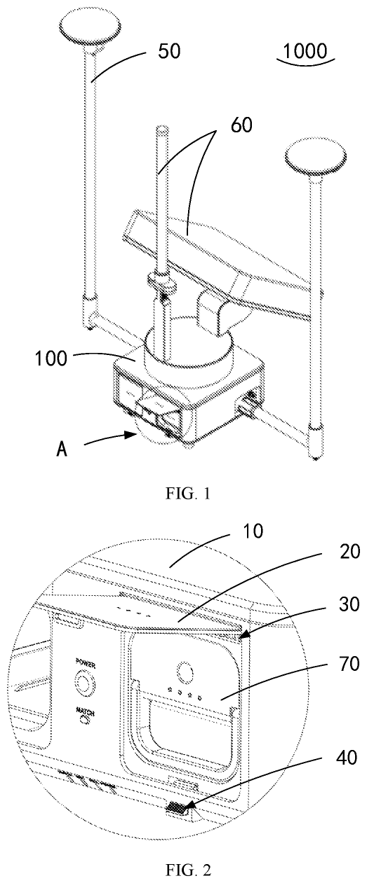

With reference to FIGS. 1 and 2, the accommodation mechanism 100 includes a housing 10, a cover plate 20, a connection assembly 30 and a locking assembly 40, wherein the housing 10 is provided with a battery holder 12 formed from a side wall of the housing 10 facing towards an internal recess of the housing 10, and the battery holder 12 is configured to accommodate a battery; the connection assemblies 30 are respectively connected to one end of the cover plate 20 and the housing 10, the cover plate 20 is configured to rotate relative to the housing 10 to open or close the opening of the battery holder 12, and a locking assembly 40 is provided to the housing 10 and is configured to lock or unlock the cover plate 20.

By providing the cover plate 20 at an opening of the battery holder 12, a direct exposure of the power supply assembly 70 to the outside can be avoided, the working environment of the power supply assembly 70 can be improved, and the service life of the power supply assembly 70 can be extended; and by providing the locking assembly 40, the cover plate 20 can be locked on the housing 10, the protection effect on the battery can be enhanced, and the cover plate 20 can be prevented from opening relative to the housing 10 under the force of external wind, etc. thus affecting the working environment of the power supply assembly 70. In addition, the engagement of the locking assembly 40 with the connection assembly 30 may facilitate the opening of the cover plate 20 and the access of the battery.

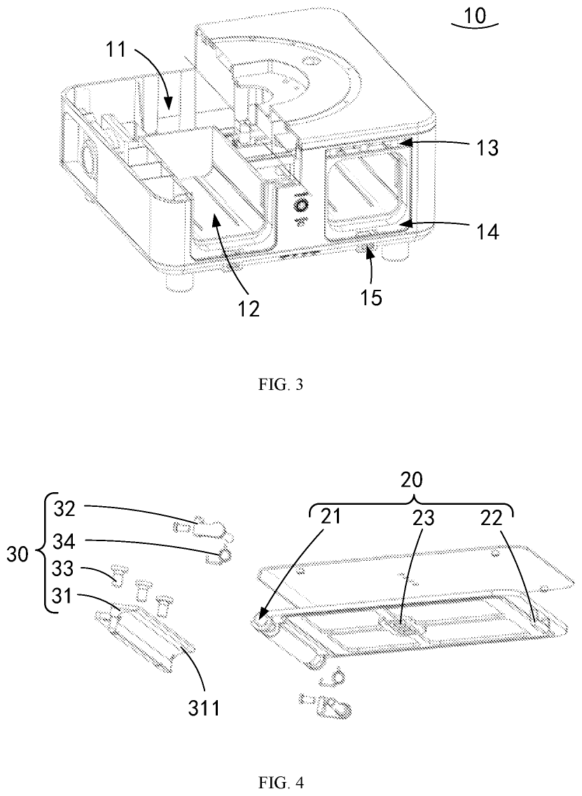

With regard to the above-mentioned the housing 10, referring to FIG. 3, the housing 10 is provided with an accommodating cavity 11 for accommodating a controller, a battery holder 12 is concavely formed from a side wall surface of the housing 10 facing the accommodating cavity 11, the battery holder 12 forms an opening of the battery holder 12 at the side wall surface of the housing 10, the battery holder 12 is configured to accommodate the power supply assembly 70, a cover plate 20 is provided at the opening, and the cover plate 20 is configured to open the opening or close the opening.

In some embodiments, the housing 10 is further provided with a mounting cavity 13 concavely formed from a side wall surface of the housing 10 toward the accommodating cavity 11, the mounting cavity 13 forms a opening of the mounting cavity 13 at the side wall surface of the housing 10, a connection assembly 30 is provided in the mounting cavity 13, and the connection assembly 30 is connected to one ends of the housing 10 and the cover plate 20, respectively to rotate with respect to the housing 10 to open or close the opening of the battery holder 12.

In some embodiments, the side wall surface of the housing 10 is further provided with a groove 14, the above-mentioned opening of the battery holder 12 and the opening of the mounting cavity 13 are both located at the bottom of the groove 14 communicating the battery holder 12 with the mounting cavity 13, and the groove 14 is configured to accommodate the cover plate 20, so that when the cover plate 20 is covered on the opening of the battery holder 12, the surface of the cover plate 20 facing away from the battery holder 12 is flush with the side wall surface of the housing 10. By providing the recess 14 to receive the cover plate 20, the volume of the housing 10 can be reduced while also enhancing the aesthetics of an accommodation mechanism 100.

In some embodiments, the housing 10 is further provided with a sliding groove 15 at both ends of the groove 14, the sliding groove 15 and the mounting cavity 13, respectively, for receiving the locking assembly 40 and allowing the locking assembly 40 to reciprocate within the sliding groove 15.

With regard to the above-mentioned cover plate 20, referring to FIG. 4, a cover plate 20 is provided with a rotating groove 21, a locking part 22 and an electricity quantity display hole 23. The rotating groove 21 and the locking part 22 are respectively located at opposite ends of the cover plate 20, and the rotating groove 21 is used to be coupled with the connection assembly 30 so that the cover plate 20 is configured to rotate with respect to the housing 10. The locking part 22 is adapted to couple with the locking assembly 40 such that the locking assembly 40 is capable of locking the cover plate 20 when the cover plate 20 closes the opening of the battery holder 12. The electricity quantity display hole 23 penetrates the cover plate 20 in the thickness direction of the cover plate 20.

With respect to the connection assembly 30 described above, referring to FIG. 4, the connection assembly 30 includes a pressing plate 31, a rotating shaft 32, and a fastener 33. The rotating shaft 32 is inserted into a rotating groove 21 of the cover plate 20 and then fixed to the pressing plate 31, and one end of the cover plate 20 is configured to rotate around the rotating shaft 32. A pressing plate 31 is provided in the mounting cavity 13, and a fastener 33 fixes the pressing plate 31 to the housing 10, thereby rotatably connecting the cover plate 20 with the housing 10. It is understood that, in order to enhance the rotational smoothness between one end of the cover plate 20 and the rotating shaft 32, the rotating shaft 32 is provided as a rotational fulcrum on both sides of the rotating groove 21 of the cover plate 20, respectively.

In some embodiments, the connection assembly 30 further includes a first elastic member 34, wherein the first elastic member 34 is sleeved on the rotating shaft 32, and both ends of the first elastic member 34 are respectively abutted against the pressing plate 31 and the cover plate 20, and the first elastic member 34 is in a compressed state. The first elastic member 34 serves to provide a resilient force for the cover plate 20 to open the opening of the battery holder 12.

In some embodiments, the pressing plate 31 extends a limiting boss 311 in a direction away from the accommodation cavity 11, and when the cover plate 20 is in a maximum opening state, the limiting boss 311 abuts against a surface of the cover plate 20 facing away from the battery holder 12, and the limiting boss 311 serves to limit the maximum opening and closing angle of the cover plate 20, so that the first elastic member 34 is always in a compressed state to ensure that the first elastic member 34 stores elastic potential energy.

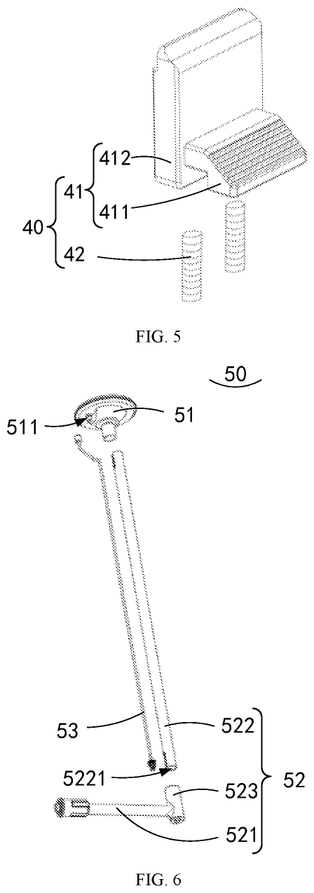

As for the locking assembly 40 described above, referring to FIG. 5, the locking assembly 40 includes a button 41 and a second elastic member 42. The button 41 includes a pressing part 411 and a sliding part 412, wherein the sliding part 412 is slidably provided in the sliding groove 15, the sliding part 412 is configured to plug with a locking part 22, the pressing part 411 is connected to the sliding part 412 and the pressing part 411 protrudes out of the sliding groove 15, the second elastic member 42 is provided in the sliding groove 15 and the two ends of the second elastic member 42 respectively abut against the sliding part 412 and the inner wall of the sliding groove 15, and the second elastic member 42 is configured to provide the sliding part 412 with a force towards the connection assembly 30.

Specifically, the sliding part 412 of the button 41 is engaged with the locking part 22 of the cover plate 20 when the cover plate 20 closes the opening of the battery holder 12. When an external force is applied to the pressing part 411 of the button 41, the sliding part 412 moves in the sliding groove 15 in a direction away from the connection assembly 30 until the sliding part 412 is separated from the locking part 22 of the cover plate 20; at this time, under the elastic force of the first elastic member 34, one end of the cover plate 20 rotates relative to the housing 10 about the rotating shaft 32 until the surface of the cover plate 20 facing away from the battery holder 12 abuts against a limiting boss 311 of the pressing plate 31, completing the process of opening by the cover plate 20 an opening of the battery holder 12.

It will be appreciated that in other embodiments, the locking assembly 40 and the connection assembly 30 may be provided on adjacent sides of the cover plate 20, respectively, i.e. the locking assembly 40 locks the cover plate 20 to the housing 10 from the sides of the cover plate 20 to promote flexibility in the placement of the locking assembly 40.

In some embodiments, the surface of the pressing part 411 is provided with an anti-slip protrusion for enhancing the roughness of the surface of the pressing part 411 to facilitate pressing by a user.

The present disclosure also provides an embodiment of an unmanned aerial vehicle tracking device 1000, and with reference to FIGS. 1 and 2, the unmanned aerial vehicle tracking device 1000 comprises a real-time dynamic measurement assembly 50, an antenna assembly 60, a power supply assembly 70, a controller and the above-mentioned accommodation mechanism 100, wherein the real-time dynamic measurement assembly 50 and the antenna assembly 60 are all provided in a housing 10, the power supply assembly 70 is provided in a battery holder 12, the controller is provided in an accommodation cavity 11, a cover plate 20 is provided at an opening of the battery holder 12, and the cover plate 20 is configured to cover the opening of the battery holder 12. By providing the cover plate 20 at an opening of the battery holder 12, a direct exposure of the power supply assembly 70 to the outside can be avoided, the working environment of the power supply assembly 70 can be improved, and the service life of the power supply assembly 70 can be extended.

As for the real-time dynamic measurement assembly 50 described above, referring to FIG. 6, the real-time dynamic measurement assembly 50 includes a real-time dynamic measurement element 51, a support frame 52, and a connecting cable 53. One end of the support frame 52 is detachably fixed to a side wall surface of the housing 10, and the other end of the support frame 52 is configured to mount the real-time dynamic measurement element 51. The real-time dynamic measuring element 51 is provided with a first joint 511, one end of the connecting cable 53 is connected to the first joint 511, and the other end is fixed to the support frame 52. In some embodiments, the number of real-time dynamic measurement assemblies 50 is two, and the two sets of real-time dynamic measurement assemblies 50 are provided on opposite sides of the housing 10.

The support frame 52 includes a first rod 521, a second rod 522, and a connecting member 523. A first end of the first rod 521 is screwed and fixed to the housing 10, a connecting member 523 is respectively connected to a second end of the first rod 521 and a first end of the second rod 522, a second end of the second rod 522 is connected to the real-time dynamic measurement element 51, and the first rod 521 and the second rod 522 are provided perpendicular to each other. It will be appreciated that in other embodiments, the first end of the first rod 521 may be connected to the housing 10 by a plug, snap, weld, or adhesive connection. An angle between the first rod 521 and the second rod 522 may be set at any angle.

The second rod 522 is provided with a through groove 5221, that is, the second rod 522 has a hollow tubular shape. The connecting cable 53 is provided in the through-groove 5221, one end of the connecting cable 53 is connected to the first joint 511 of the real-time dynamic measurement element 51, the other end of the connecting cable 53 is fixed to the first end of the second rod 522 and protrudes out of the through-groove 5221, and the other end of the connecting cable 53 is used for electrical connection with other external devices. By providing the through groove 5221, the connecting cable 53 can be buried inside the second rod 522, avoiding direct exposure of the connecting cable 53 to the outside, and effectively extending the service life of the connecting cable 53.

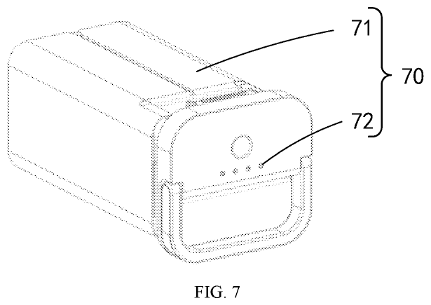

With regard to the above-mentioned power supply assembly 70, referring to FIG. 7, the power supply assembly 70 comprises a battery body 71 and an indicator lamp 72, wherein the indicator lamp 72 is provided at one end of the battery body 71, and the indicator lamp 72 is electrically connected to the battery body 71, and the indicator lamp 72 is configured to display information about the remaining power of the battery body 71 so as to be configured to timely find and understand the power condition of the battery body 71. The position of the electric quantity display hole 23 corresponds to the position of the indicator lamp 72 on the battery body 71, and after the cover plate 20 closes the opening of the battery holder 12, a user can directly observe the light-off condition of the indicator lamp 72 from the outside of the battery holder 12 through the electric quantity display hole 23 on the cover plate 20, and then determine the usage condition of the battery body 71. In addition, the heat generated during the operation of the battery body 71 can also be directly emitted to the outside through the electric quantity display hole 23 of the cover plate 20, thereby preventing the temperature in the battery holder 12 from being excessively high and affecting the operation performance of the battery body 71.

The present disclosure also provides an embodiment of an unmanned aerial vehicle tracking system including the above-mentioned unmanned aerial vehicle tracking device 1000, and reference can be made to the above-mentioned embodiment for the specific structure and function of the unmanned aerial vehicle tracking device 1000, which will not be described in detail herein.

The above-mentioned embodiments are merely examples of the present disclosure and do not limit the scope of the patent of the present disclosure. Any equivalent structure or equivalent process changes made by using the contents of the description and the drawings of the present disclosure or directly or indirectly used in other relevant technical fields are likewise included in the scope of the patent protection of the present disclosure.

What is claimed is:

1. An accommodation mechanism, comprising:
a housing provided with a battery holder formed from a side wall of the housing facing an internal recess of the housing;
the battery holder being configured to accommodate a battery;
a connection assembly and a cover plate, the connection assembly being respectively connected to one end of the cover plate and the housing, the cover plate being configured to rotate relative to the housing; the cover plate being configured to open or cover an opening of the battery holder; and
a locking assembly provided at the housing, the locking assembly being configured to lock or unlock the cover plate.

2. The accommodation mechanism according to claim 1, wherein the connection assembly comprises:
a pressing plate;
a rotating shaft fixed to the pressing plate, one end of the cover plate being provided with a rotating groove, the rotating shaft being inserted into the rotating groove; and
a fastener for fixing the pressing plate to the housing.

3. The accommodation mechanism according to claim 2, wherein the housing is further provided with a mounting cavity located at a side wall of the housing and communicating with the outside, and the mounting cavity is configured to receive the connection assembly.

4. The accommodation mechanism according to claim 3, wherein the housing is further provided with a groove, the opening of the battery holder and an opening of the mounting cavity are both located at the bottom of the groove, the groove communicates the battery holder with the mounting cavity, the groove is configured to accommodate the cover plate, and when the opening of the battery holder is covered by the cover plate, the surface of the cover plate facing away from the battery holder is flush with a side wall surface of the housing.

5. The accommodation mechanism according to claim 2, wherein
the connection assembly further comprises a first elastic member sleeved on the rotating shaft, and two ends of the first elastic member respectively abut against the pressing plate and the cover plate;
the housing is further provided with a sliding groove, the locking assembly is configured to slide back and forth in the sliding groove, and the cover plate is further provided with a locking part; and
the first elastic member is in a compressed state when the locking assembly is connected to the locking part and the cover plate covers the opening, and when the locking assembly is separated from the locking part, the cover plate opens the opening under the elastic force of the first elastic member.

6. The accommodation mechanism according to claim 5, wherein
the locking part is located at the other end of the cover plate, and the locking assembly and the connection assembly are respectively located at two opposite sides of the opening;
the locking assembly comprises a button and a second elastic member, wherein the button comprises a pressing part and a sliding part slidably provided in the sliding groove and being configured to be inserted into the locking part, the pressing part is connected to the sliding part and the pressing part protrudes out of the sliding groove, two ends of the second elastic member respectively abut against the sliding part and an inner wall of the sliding groove, and the second elastic member is configured to provide the sliding part with a force towards the connection assembly.

7. An unmanned aerial vehicle tracking device, comprising a real-time dynamic measurement assembly, an antenna assembly, a power supply assembly, a controller and an accommodation mechanism, wherein the accommodation mechanism comprises:
a housing provided with a battery holder formed from a side wall of the housing facing an internal recess of the housing;
the power supply assembly is provided in the battery holder;
the battery holder being configured to accommodate a battery;
a connection assembly and a cover plate, the connection assembly being respectively connected to one end of the cover plate and the housing, the cover plate being rotatable relative to the housing; the cover plate being configured to open or cover an opening of the battery holder; and
a locking assembly provided at the housing, the locking assembly being configured to lock or unlock the cover plate;
the housing is further provided with an accommodating cavity;
the controller is provided in the accommodation cavity, and the controller is electrically connected to the real-time dynamic measurement assembly, the antenna assembly and the power supply assembly, respectively; and
the real-time dynamic measurement assembly and the antenna assembly are both provided on an outer surface of the housing, and the antenna assembly is configured to rotate relative to the housing.

8. The unmanned aerial vehicle tracking device according to claim 7, wherein
the cover plate is provided with an electric quantity display hole; the power supply assembly comprises a battery body and an indicator lamp; the indicator lamp is electrically connected to the battery body; the indicator lamp corresponds to the electric quantity display hole; and the indicator lamp is configured to display the remaining electric quantity of the battery body.

9. The unmanned aerial vehicle tracking device according to claim 7, wherein
the real-time dynamic measurement assembly comprises a real-time dynamic measurement element, a support frame and a connecting cable, wherein one end of the support frame is fixed to a side wall of the housing, and the other end of the support frame is connected to the real-time dynamic measurement element; the real-time dynamic measurement element is provided with a first joint, one end of the connecting cable is connected to the first joint, and the other end of the connecting cable is fixed to the support frame; and the connecting cable is configured to connect with an external detection device.

10. The unmanned aerial vehicle tracking device according to claim 9, wherein
the support frame comprises a first rod, a second rod and a connector, wherein a first end of the first rod is fixed to a side wall of the housing, the connector is respectively connected to a second end of the first rod and a first end of the second rod, a second end of the second rod is connected to the real-time dynamic measurement element, and the first rod and the second rod are perpendicular.

11. The unmanned aerial vehicle tracking device according to claim 10, wherein
a through groove is provided inside the second rod, the connecting cable is provided in the through groove, and the other end of the connecting cable is fixed to the first end of the second rod and protrudes out of the through groove.

12. An unmanned aerial vehicle tracking system, comprising an unmanned aerial vehicle tracking device; wherein the unmanned aerial vehicle tracking device comprises:
a real-time dynamic measurement assembly, an antenna assembly, a power supply assembly, a controller and an accommodation mechanism, wherein the accommodation mechanism comprises:
a housing provided with a battery holder formed from a side wall of the housing facing an internal recess of the housing;
the power supply assembly is provided in the battery holder;
the battery holder being configured to accommodate a battery;
a connection assembly and a cover plate, the connection assembly being respectively connected to one end of the cover plate and the housing, the cover plate being configured to rotate relative to the housing; the cover plate being configured to open or cover an opening of the battery holder; and
a locking assembly provided at the housing, the locking assembly being configured to lock or unlock the cover plate;
the housing is further provided with an accommodating cavity;
the controller is provided in the accommodation cavity, and the controller is electrically connected to the real-time dynamic measurement assembly, the antenna assembly and the power supply assembly, respectively; and
the real-time dynamic measurement assembly and the antenna assembly are both provided on an outer surface of the housing, and the antenna assembly is configured to rotate relative to the housing.

13. The unmanned aerial vehicle tracking system according to claim 12, wherein
the cover plate is provided with an electric quantity display hole; the power supply assembly comprises a battery body and an indicator lamp; the indicator lamp is electrically connected to the battery body; the indicator lamp corresponds to the electric quantity display hole; and the indicator lamp is configured to display the remaining electric quantity of the battery body.

14. The unmanned aerial vehicle tracking system according to claim 12, wherein
the real-time dynamic measurement assembly comprises a real-time dynamic measurement element, a support frame and a connecting cable, wherein one end of the support frame is fixed to a side wall of the housing, and the other end of the support frame is connected to the real-time dynamic measurement element; the real-time dynamic measurement element is provided with a first joint, one end of the connecting cable is connected to the first joint, and the other end of the connecting cable is fixed to the support frame; and the connecting cable is configured to connect with an external detection device.

15. The unmanned aerial vehicle tracking system according to claim 14, wherein
the support frame comprises a first rod, a second rod and a connector, wherein a first end of the first rod is fixed to a side wall of the housing, the connector is respectively connected to a second end of the first rod and a first end of the second rod, a second end of the second rod is connected to the real-time dynamic measurement element, and the first rod and the second rod are perpendicular.

16. The unmanned aerial vehicle tracking device according to claim 15, wherein
a through groove is provided inside the second rod, the connecting cable is provided in the through groove, and the other end of the connecting cable is fixed to the first end of the second rod and protrudes out of the through groove.
